(19) United States
(12) Patent Application Publication
(10) Pub. No.: US 2022/0006136 A1
(43) Pub. Date: Jan. 6, 2022

(54) INTEGRATED BATTERY UNIT

(71) Applicant: Freudenberg-NOK General Partnership, Plymouth, MI (US)

(72) Inventor: Alexander BERDICHEVSKY, Farmington Hills, MI (US)

(73) Assignee: Freudenberg-NOK General Partnership, Plymouth, MI (US)

(21) Appl. No.: 17/295,372

(22) PCT Filed: Dec. 2, 2019
(86) PCT No.: PCT/US2019/064006

§ 371 Date: May 19, 2021

Related U.S. Application Data
(60) Provisional application No. 62/775,080, filed on Dec. 4, 2018.

(51) Int. Cl. H01M 10/659; H01G 4/40; H01M 10/42; H01M 10/44; H01M 10/613; H01M 10/6569; H01M 50/213; H01M 10/643; H01M 10/653

(52) U.S. Cl. CPC H01M 10/659; H01G 4/40; H01M 10/4207; H01M 10/4264; H01M 10/4257; H02J 7/0042; H01M 10/613; H01M 10/6569; H01M 50/213; H01M 10/643; H01M 10/653; H01M 10/441

(57) ABSTRACT

An integrated battery unit includes a battery cell and a graphite matrix surrounding the battery cell, wherein the graphite matrix is soaked with a phase change material. Each of the integrated battery units include an integrated circuit board that manages charging and discharging of the battery cell based upon data received from adjacent integrated battery units and a communication from the sources external to the battery pack. A hybrid battery unit can also include a capacitor function that temporarily stores and discharges electric charge and can be controlled by the integrated circuit board.

### CROSS-REFERENCE TO RELATED APPLICATIONS

This application is a National Stage of International Application No. PCT/US2019/064006, filed Dec. 2, 2019 (now WO 2020/117672 A1), which claims the benefit and priority of U.S. Provisional Application No. 62/775,080, filed Dec. 4, 2018. The entire disclosures of each of the above applications are incorporated herein by reference.

### FIELD

The present disclosure relates to an integrated battery unit.

### SUMMARY

The integrated battery unit can include a battery cell and a graphite matrix surrounding the battery cell, wherein the graphite matrix is soaked with a phase change material. Each of the integrated battery units include an integrated circuit board that manages charging and discharging of the battery cell based upon data received from adjacent integrated battery units. A hybrid battery unit and a capacitor also includes a capacitor function that temporarily stores and discharges electric charge and can be controlled by the integrated circuit board.

### DRAWINGS

The drawings described herein are for illustrative purposes only of selected embodiments and not all possible implementations, and are not intended to limit the scope of the present disclosure.

FIG. 1 is a schematic perspective view of an integrated battery unit according to the principles of the present disclosure;

FIG. 2 is a schematic illustration of an arrangement of integrated battery units according to the principles of the present disclosure;

FIG. 3 is a schematic illustration of an alternative arrangement of integrated battery units according to the principles of the present disclosure;

FIG. 4 is a schematic illustration of an arrangement of integrated battery units connected in parallel and in series according to the principles of the present disclosure;

FIG. 5 is a schematic illustration of an integrated battery unit and capacitor according to the principles of the present disclosure; and

FIG. 6 is a schematic illustration of an alternative integrated battery unit and capacitor according to the principles of the present disclosure; and

FIG. 7 is a schematic illustration of an alternative integrated battery unit and capacitor according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

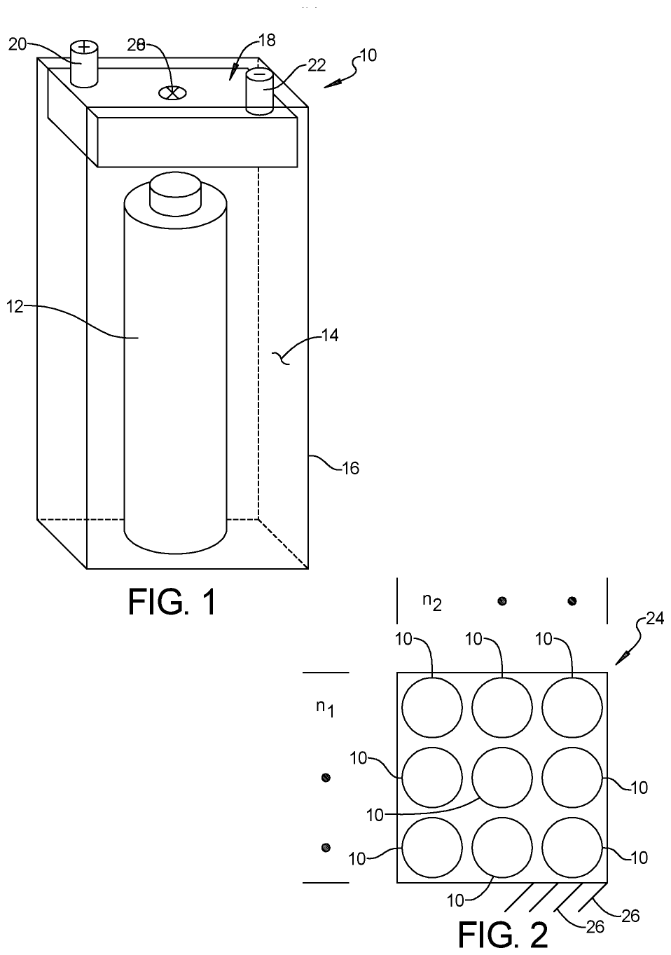

With reference to FIG. 1, an integrated battery unit 10 is shown including a battery cell 12 that is surrounded by a matrix 14 containing a phase change material. A metal cage 16 can encase the matrix 14. An integrated circuit board 18 is provided for controlling the charging and discharging of the individual battery cell 12 and can include positive and negative terminals 20, 22 that are connected to the battery cell.

The battery cell 12 can be of any known or yet unknown rechargeable chemistry-type such as, but not limited to, lithium ion, nickel cadmium, nickel-zinc, and nickel metal hydride.

The matrix 14 can be formed from compressed graphite powder or other highly porous thermally conductive material that is soaked with paraffin wax or other phase change material. The compressed graphite powder transmits heat from the battery cell 12 and the phase change material absorbs a significant portion of the heat generated by the cell.

As an alternative arrangement, the phase change material can include a fluid such as water or other inorganic or organic fluid. As the fluid absorbs heat, the fluid can change from fluid to vapor for absorbing a significant portion of the heat generated by the cell during the change in phase. The amount of fluid can be tuned to limit the internal integrated battery unit pressure and the fluid and the initial pressure inside the integrated battery unit can be chosen to provide a proper evaporation temperature. Overheating or over pressurization of the integrated battery unit can be controlled by a pressure relief valve.

The metal cage 16 can include a stainless steel, aluminum, other alloy or clad metal casing around the matrix 14. If utilized, the metal cage 16 can provide improved thermal event containment and excellent heat dissipation. Alternatively, the matrix 14 can be coated with a coating such as a polyethylene coating or it can be caseless.

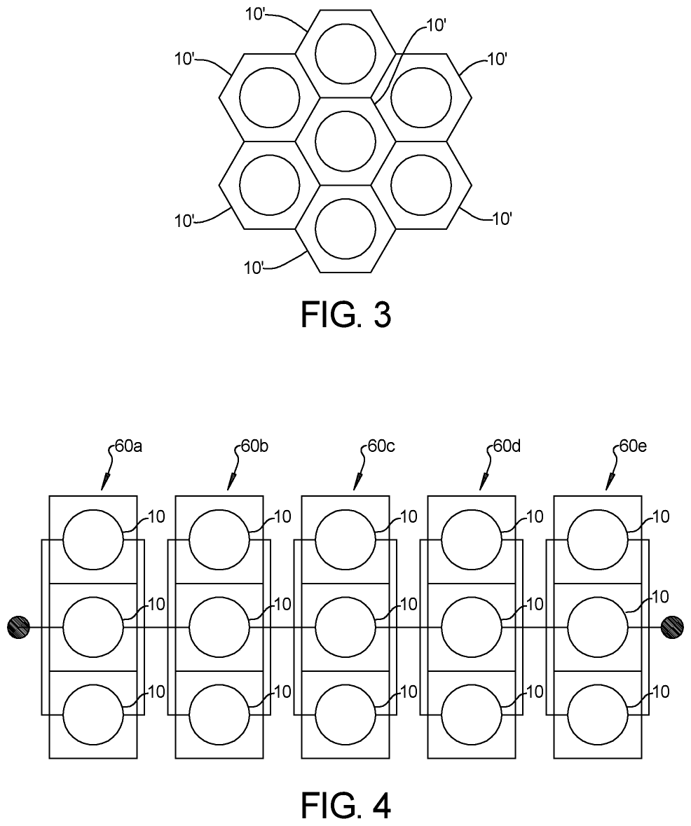

As shown in FIG. 2, the integrated battery units 10 can be square or rectangular in cross-section and arranged in a battery pack 24 in a side by side arrangement with different numbers of n1 rows and n2 columns where the number of rows and columns can be selected in order to provide a desired battery pack geometry. Alternatively, the integrated battery units 10′ can have a polygonal shaped cross-section such as the hexagon shapes shown in FIG. 3 with the faces of adjacent ones of the polygonal shaped integrated battery units 10′ being disposed against one another.

The integrated battery units 10 can be connected in a battery pack with multiple sets 60a-60e of integrated battery units 10 connected in any parallel or serial configuration as needed by a battery pack design, as illustrated in FIG. 4. The integrated battery units 10 allow for maintenance of a battery pack by removing and replacing an individual integrated battery unit 10.

The metal of the cage 16 improves heat transfer between neighboring integrated battery units 10/10′ to the outer units for radiation or cooling plate dissipation through cooling fins 26 (only a few of which are shown), as shown in FIG. 2. In the event that a battery cell experiences a thermal event, the phase change material and the porous graphite within the matrix 16 jointly with the neighboring integrated battery units 10 absorb the heat from the thermal event.

The integrated circuit board 18 collects, processes, manages and transmits the physical state of the battery cell 12. The integrated circuit board 18 also transmits the battery cell current via the positive and negative terminals 20, 22. The integrated circuit board can include a vent valve 28 to allow release of gasses from the battery cell. The integrated battery units 10 provide universal components that can be combined in battery packs having various configurations and numbers of units 10 without requiring redesign for different configurations. The universal integrated battery units 10 improve the battery pack cost structure due to volume manufacturing, ease of battery pack assembly in different configurations and improved maintenance by replacing individual integrated battery units 10.

A bus bar connection can be provided for connecting each integrated circuit board 18 to the integrated circuit boards for the immediate adjacent integrated battery units 10 for distributed logic control. The integrated circuit boards 18 can manage the individual cell charge and discharge states and can transmit and receive a temperature, a state of charge and operating mode data to and from the adjacent integrated battery units in order to process whether a neighboring integrated battery unit is experiencing a thermal event or has a state of charge or operating mode that is significantly different. Based upon the processing of the individual cell state and the data received from neighboring integrated battery units, the integrated circuit boards 18 can select different operating modes. The operating modes from each integrated battery unit can include for example, a normal recharge mode, restricted recharge mode, normal discharge mode, restricted discharge mode and thermal overload mode. Other operating states can be managed and other operating modes can also be utilized including monitoring a capacitor state of a hybrid battery unit/capacitor as described below. By sharing operating data and operating modes with neighboring battery units, the integrated circuit boards 18 can cause the battery units to converge toward a joint response to balance the voltage or state of charge of the integrated battery units 10.

The operating modes can be selected by the integrated circuit board 18 based upon the temperature and state of charge of that integrated battery unit 10 and based upon the operating modes received from neighboring integrated battery units 10. In response to the temperature and state of charge of the integrated battery unit 10 and the operating mode data from the adjacent battery units 10, the integrated circuit board 18 can make a determination to select an appropriate operating mode for those circumstances. In particular, if an adjacent integrated battery unit 10 is experiencing a thermal event, the integrated circuit boards 18 of the surrounding integrated battery units 10 may determine to cease any charging or discharging in order to reduce the heat generation thereof so as to better assist the dissipation of heat from the adjacent integrated battery unit 10 that is experiencing a thermal event. Other integrated battery units may identify that a neighboring integrated battery unit has gone into a restricted discharge mode and increase its discharge to make up for the reduce voltage supply.

A battery cell operates by converting chemical energy to electrical energy during discharge and converting electrical energy to chemical energy during charging. The present battery cells are limited in their ability to quickly charge/discharge because of the time required for the chemical reaction necessary during conversion of the electrical energy into chemical energy. According to a further aspect of the present disclosure, a hybrid battery unit/capacitor 100 can utilize the matrix 14 to perform a capacitor function to provide quick storage of electrical energy that can then be either discharged for vehicle motor operation or other functions external to the battery pack or used to recharge the battery cells. A capacitor is a circuit component with capacitance that enables it to store electric charge.

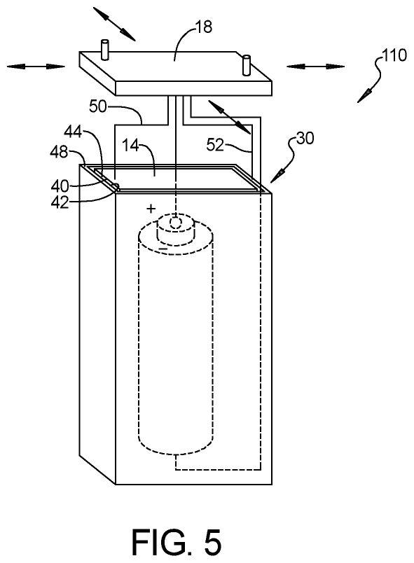

As shown in FIG. 5, a hybrid battery unit/capacitor 110 includes a capacitor 30 which is formed from a pair of conducting surfaces 40, 42 separated by an insulator layer 44. The capacitance value is proportional to the area A of one surface 40, 42 (the smaller, if the 2 are not of identical area), and inversely proportional to the separation distance d. The permittivity of the insulator 44 also contributes directly to the capacitance value. For parallel plates 40, 42 of area A m² separated by distance d of meters by a dielectric with relative permittivity εᵣ the capacitance C is given by

C=εᵣ*ε₀*A/d,

where ε₀ is the permittivity of free space.

According to an aspect of the present disclosure, the surface 40 of the graphite matrix 14 serves as a first capacitor surface and is coated with a ceramic layer 44 serving as the insulating layer 44 and a metal film 48 defining the surface 42 which serves as a second capacitor surface. A phase change material can optionally be absorbed in the graphite matrix 14. Electrodes 50, 52 are connected to the graphite matrix 14 and to the metal film 48, respectively and to the integrated circuit board 18 which controls the charge and discharge of the integrated capacitor 30. Although they are shown as a square cross section, the graphite matrix 14 and the metal film 48 can have a cylindrical shape or other desired shape.

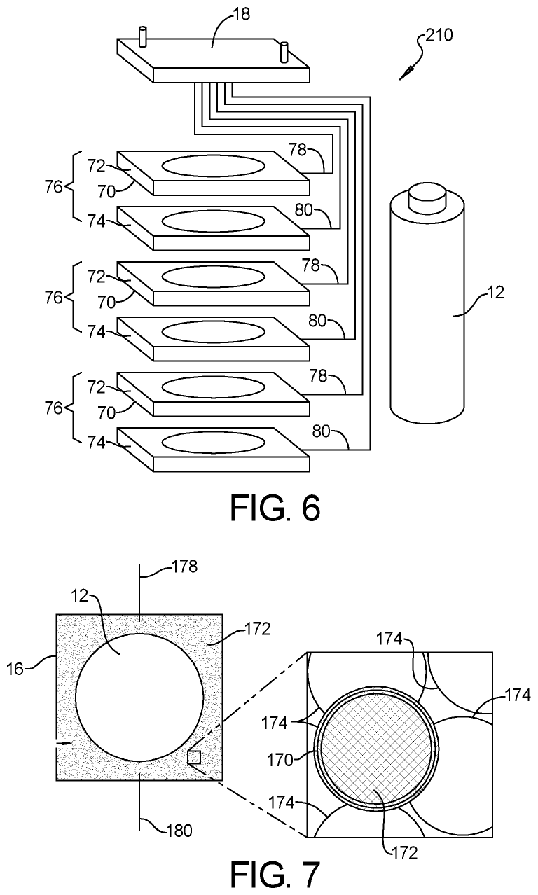

It should be understood that the integrated capacitor 30 can be implemented in other forms. According to a further aspect of the present disclosure, as shown in FIG. 6, the hybrid battery unit/capacitor 210 can be implemented as a stack of plates 72, 74 that can be separated by ceramic insulators 70 in order to operate as capacitor plates 72, 74 for multiple capacitor units 76. The capacitor plates can be formed from a graphite matrix that can be soaked with paraffin wax or other phase change material, or can be formed from other conductive materials such as aluminum, copper or the like. Each of the capacitor units 76 can include a pair of electrodes 78, 80 connected to the capacitor plates 72, 74. Each pair of electrodes 78, 80 can be connected to the integrated circuit board 18 that controls the charge and discharge of the capacitor units 76.

According to a further aspect, as schematically illustrated in FIG. 7, an exfoliated or expanded graphite can define a matrix 172 that can include graphite particles that are clustered in a three-dimensional interlinked web-like structure. A first electrode 178 can be connected to the matrix 172 and the matrix 172 can have its surface coated with a ceramic material or other insulator 170 to define the matrix 172 having a capacitor surface and an insulator layer 170. A second capacitor surface 174 can be defined by an electrically conductive film deposited onto the external surface of the insulator 170 which is connected to a second electrode. Therefore, the matrix 172 and the second capacitor surface 174 which are separated by the insulator layer 170 define a capacitor unit 176. The matrix 172 can also have a phase change material absorbed therein. The shape of the spaces within the matrix 172 can be formed randomly or by other techniques such as drilling, cutting, punching, die casting, 3-dimensional printing or other techniques. In addition, various techniques or vapor deposition, chemical expansion, chemical conversion, dipping processes and other coating processes can be utilized to create the insulator and second capacitor surface. Although the schematic illustration of FIG. 7 shows the graphite particles as spheres, the actual particle shapes are more random.

The integrated circuit boards 18 of each integrated battery unit 110, 210 provide measurement including the phase state of the phase change material, control and management of the individual integrated battery unit 10 including the integrated capacitor(s) 30, 76 if utilized.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An integrated battery unit, comprising:
a battery cell;
a graphite matrix surrounding the battery cell, wherein the graphite matrix is soaked with a phase change material.

2. The integrated battery unit according to claim 1, wherein the graphite matrix is made from graphite powder.

3. The integrated battery unit according to claim 1, wherein the phase change material is paraffin wax.

4. The integrated battery unit according to claim 1, wherein the graphite matrix is disposed in a metal cage.

5. The integrated battery unit according to claim 1, wherein the graphite matric is surrounded by a coating.

6. The integrated battery unit according to claim 1, further comprising an integrated circuit board connected to the battery cell for controlling charging and discharging of the battery cell.

7. A hybrid integrated battery unit and capacitor, comprising:
a battery cell; and
a capacitor surrounding the battery cell.

8. The hybrid integrated battery unit and capacitor according to claim 7, wherein the capacitor includes a first conductive surface separated from a second conductive surface by the insulating material.

9. The hybrid integrated battery unit and capacitor according to claim 9, wherein the capacitor includes multiple conductive rings surrounding the battery cell and separated by the insulating material.

10. The hybrid integrated battery unit and capacitor according to claim 9, wherein the capacitor includes a first conductive prismatic surface and a second conductive prismatic surface separated by the insulating material.

11. A battery system, comprising:
a plurality of integrated battery units each including a battery cell; and
an integrated circuit board connected to the battery cell for controlling charging and discharging of the battery cell,
wherein the integrated circuit boards of the plurality of integrated battery units are connected to adjacent ones of the plurality of integrated battery units and provide data to the adjacent ones of the plurality of integrated battery units regarding the battery cell.

12. The battery system according to claim 11, wherein the integrated circuit boards of the plurality of integrated battery units manage charging and discharging of the battery cell based upon the data received from the adjacent integrated battery units.
